(19) United States
(12) Patent Application Publication
(10) Pub. No.: US 2007/0094095 A1
(43) Pub. Date: Apr. 26, 2007

(54) INTERNET ANTI-FRAUD CARDHOLDER VERIFICATION SYSTEM

(76) Inventor: Brian G. KILBY, Atlantic Beach, FL (US)

Correspondence Address: HITCHCOCK EVERT LLP, P.O. BOX 131709, DALLAS, TX, 75313-1709, US

(21) Appl. No.: 11/552,820

(22) Filed: Oct. 25, 2006

Related U.S. Application Data
(60) Provisional application No. 60/730,407, filed on Oct. 26, 2005.

(51) Int. Cl. G06Q 30/00

(52) U.S. Cl. 705/26

(57) ABSTRACT

A method for detecting on-line fraudulent transactions is presented. In at least one embodiment, the method comprises the steps of registering a potential customer, receiving customer data comprising at least a customer telephone number having a customer area code and customer exchange and a customer address having a customer ZIP code, and calculating a distance between said customer ZIP code and at least one of said customer area code and customer exchange. In some embodiments of the method, customer registration will be rejected if the distance between at said customer ZIP code and at least one of said customer area code and customer exchange is too large. In additional embodiments, if a customer is registered, additional security measures are employed increase the likelihood of preventing fraud by attempting to verify the identity of the customer.

### CROSS-REFERENCE TO RELATED APPLICATIONS

This application claims the benefit of priority from U.S. Provisional Application No. 60/730,407 filed Oct. 26, 2005.

### FIELD OF THE INVENTION

The present invention relates to a system and method for reducing or eliminating instances of fraud in on-line transactions.

### BACKGROUND OF THE INVENTION

Internet transactions are an increasingly common method to process orders for customers any time or day of the week. Payment for goods and services has typically been conducted with a merchant account that allows the merchant to accept a customer's credit card, debit card, electronic check or other form of payment. Other merchant accounts also allow the merchant to accept checks or other forms of payment such as PayPal, or other debit forms of payment. Because credit cards remain one of the most accepted methods of on-line payment, the present invention will be presented in terms of preventing credit card fraud. Those skilled in the art will recognize that the present method may be equally applicable to alternate methods of payment such as debit cards, electronic checks, and other forms of payment such as Paypal and the like.

To obtain a merchant account, a merchant may enter into an agreement with a bank. Most merchant accounts require that the merchant agree to be fully liable to the bank for all chargebacks. Additionally, for some smaller merchants, a personal guarantee may be required from an owner or officer of the merchant. In these instances, the merchant owner/officer may become personally liable for all chargebacks occurring on the merchant account. However, some sectors of the online industry typically sees a chargeback rate of over 1% (1 in a 100 transactions) and attempted fraud rates (defined as an attempt to improperly obtain merchandise but for the actions of a merchant which prevent the order or through some automatic anti-fraud detection means) of well over 10%. A chargeback however, is a debit against the merchant account for the cost of the transaction plus a chargeback fee typically ranging from $15 to $35 per incident. In the case of a chargeback, the merchant may have also lost merchandise in the transaction.

Many times, fraud or chargebacks occur when a stolen credit card, or credit card improperly issued in the name of an innocent third party and used by another for improper purposes, are used to initiate a transaction. In these instances, if a merchant is able to detect the use of a stolen or otherwise improperly obtained card, it may be able to halt the transaction before it is completed, thereby avoiding lost merchandise and chargeback fees.

The present invention provides a method for adding multiple layers of security to an on-line transaction, such as, for example, providing means for increasing the likelihood that the credit card number used in a transaction is genuine and is being used by the actual owner of the that credit card. It has been found that use of the present method may reduce the number of chargeback transactions to as little as 0.1% (1 in a 1,000) of all transactions. Use of the present invention has the additional advantage of reducing the number of transactions for which an officer/owner of the merchant may be personally liable.

### SUMMARY OF THE INVENTION

The present invention relates to a method for reducing instances of on-line fraud. Specifically, the method of the present invention first involves registering a potential customer, such as by acquiring customer data such as name, address and telephone number. In this step, the merchant may attempt to verify that the person entering information is entering genuine information and is not attempting to defraud the merchant. Second, only after a customer is accepted by the merchant in the registration process, a purchase processing step adds additional levels of security, again in an attempt to ensure that there is a match between the payment information entered and the identity of the person placing the order.

### BRIEF SUMMARY OF THE DRAWINGS

The present invention will be more fully understood from embodiments of the invention described in the detailed description together with the drawings provided to aid in understanding, but not limit the invention.

FIG. 1 is a flowchart depicting the customer registration process.

FIG. 2 is a flowchart depicting the customer payment process.

### DETAILED DESCRIPTION OF PREFERRED EMBODIMENTS

The following description of the preferred embodiments is merely exemplary in nature and is in no way intended to limit the invention, its application, or uses.

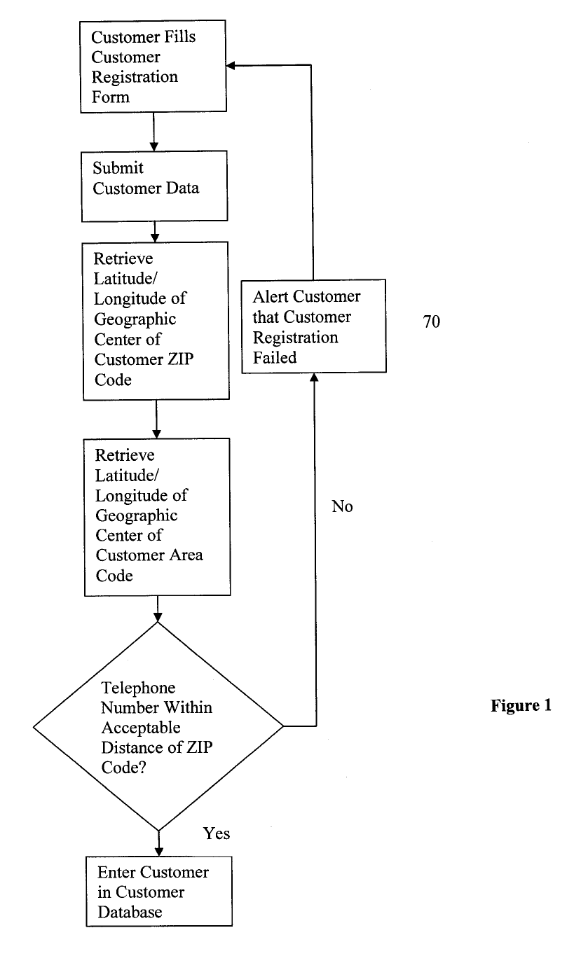

With reference to FIG. 1, the method of the present invention begins with customer registration process. In step 10, customers are required to fill a customer registration form with data such as, for example, a first name, last name, address 1, address 2, city, state, zip code/postal code and telephone number. Generally, as more data is gathered, the chances of detecting a fraud attempt will rise. Technology for creating on-line forms or other means for accepting data are known in the art. In step 20, customer data is submitted to a central processing means, such as a merchant's computer.

With this information in hand, a merchant may be able to complete a transaction. However, because it is possible for thieves to falsify consumer data, including credit card, name and address information, the method of the present invention initiates the first of a number of steps to detect a possibly fraudulent transaction. Although the following step is depicted in FIG. 1, and is described herein as the first step, it should be understood that the following steps and additional steps described below may be undertaken in various orders without deviating from the scope of the invention.

In step 30, aspects of the customer data input in step 10 are identified to be used in the verification process. In a preferred embodiment, the customer's telephone number and ZIP code is identified. Next, based on the ZIP code given by the customer, the latitude and longitude of the geographic center of that ZIP code is retrieved by the system. A database of latitude/longitude coordinates for each ZIP code may be generated by the merchant, or the merchant may purchase such a database, or subscribe to a service which provides that service. Those skilled in the art will recognize that databases of this type are readily available for the United States, Canada, Mexico, parts of Europe and elsewhere.

Continuing this preferred embodiment, in step 40, the telephone number given by the customer is analyzed to determine the geographic location to which the number was assigned. In particular, as area codes, and the local exchange numbers used within an area code are particular to a given geographic region, it is possible to use a database of such area codes and exchanges to identify the location of the telephone number given by the customer.

In step 50, the method of the present invention calculates the distance between the geographic location of the given ZIP code and given area code/exchange. Although there are a number of methods that could be used to calculate the distance between two locations, in a preferred embodiment, because of the near-spherical shape of the Earth, calculating an accurate distance between two points requires the use of spherical geometry and trigonometric math functions. For example, the following calculation will output a distance in statute miles:
r*acos[sin(lat1)*sin(lat2)+cos(lat1)*cos(lat2)*cos(lon2−lon1)].
Where: r is the radius of the Earth in miles (3963.0 (statute miles)); lat1 is the latitude of a first location; lon1 is the longitude of a first location; lat2 is the latitude of a second location; and lon2 is the longitude of a second location and wherein a first location may be, for example, the location of the ZIP code and a second location may be the location of the area code/exchange. Finally, if the latitude and longitude data provided by the databases referenced in steps 30 and 40 is given in decimal degrees, they must be converted to radians by dividing the latitude and longitude values in degrees by 180/pi, or approximately 57.29577951.

It is believed that some thieves will use stolen credit card/cardholder information relating to an innocent third person that is not geographically close. For example, a thief in Los Angeles may use credit card/cardholder information from a victim located in New York City. As is discussed below, in some embodiments of the method of the present invention, it is required that a valid telephone number be given in step 10 and further that a practitioner of the present method verify the given telephone number by actually placing a call to that number. Thus, a thief attempting to use information stolen from a victim in New York City will have to provide a valid telephone number at his or her location in Los Angeles. By calculating the distance between the ZIP code associated with the credit card and the area code/exchange of the given telephone number, it is possible to at least identify transactions which may have an increased likelihood of being fraudulent. While there are certainly a number of legitimate reasons why an actual cardholder may provide a telephone number which is geographically remote from the address associated with his or her credit card, this distance calculation may be effective as a early indicator of a potential fraud attempt.

Therefore, once the distance calculation has been completed, the resulting value may be compared against a target threshold to determine if the ZIP codes and telephone area code/exchange are acceptably geographically close. In this preferred embodiment, the target threshold is 100 miles and in an exemplary embodiment, a target threshold of 55 miles may be selected, although the selection of a target threshold either greater than 100 miles or less than 55 miles will not deviate from the present invention. In the exemplary embodiment, so long as the distance between the ZIP code and the area code/exchange is less than or equal to 55 miles, the present method will continue to step 60 and the customer is entered into the customer database. If the distance between the ZIP code and the area code/exchange is greater than 55 miles, at step 70, the customer is alerted that the customer registration process has failed and the process returns to step 10.

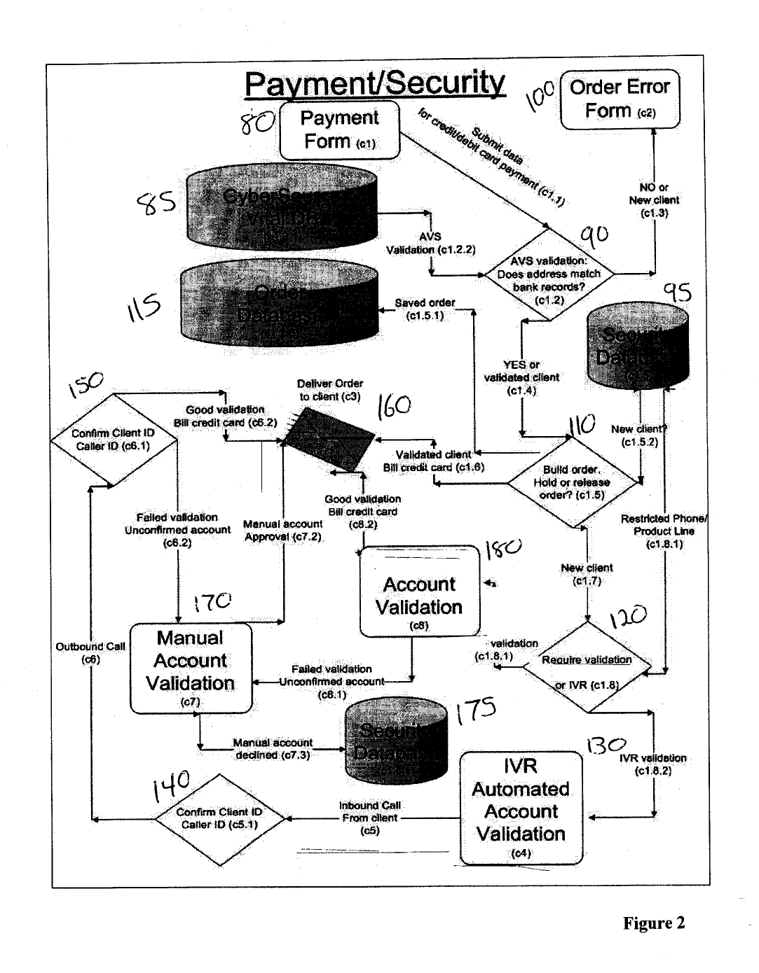

Turning to FIG. 2, once a customer has been entered into the customer database, the present method moves to the payment/security phase. In this phase, the registered customer may complete shopping by any one of a number of technologies known in the art, and generally be adding items to its on-line “shopping basket.” Once the potential customer has completed shopping, the potential customer's identity is verified. Thus, when the customer has added the items into their basket to purchase, they choose to checkout and pay the amount of the goods and services selected. The customer may be presented with several alternative payment methods including, for example, credit card, debit card, electronic check, store credit, or an online debit system. At step 80, the merchant may demand additional information regarding the method of payment such as a full credit/debit card number, expiration date and any other card specific requirements such as CVV code, or password.

At step 90, the payment information may be transmitted to a verification means, such as for example, a third party company such as CyberSource Corporation, represented as block 85. As is known in the art, address verification systems typically contact the issuing bank or financial institution which issued the payment form, such as a credit card to determine if a particular set of data matches with customer data stored by the issuing bank. In general, the address verification system will provide the merchant with a code indicating that the provided information matches the known information or not. Thus, the customer information provided in step 80 may be checked in step 90 against records of known identities/addresses in an attempt to ensure a valid transaction.

If in step 90 it is determined that the information provided in step 80 does not agree with known information, the method moves to step 100 where an order error form is generated and, as shown in FIG. 2, the method may halt. In alternate embodiments, the method may return to step 80 where the potential customer may be given the opportunity to re-enter information. If, however, in step 90 it is determined that the information provided in step 80 does agree with known information, the method moves to step 110.

In step 110, the order may be completed within the merchant database. Completion of the order may include generation of an order header record, order detail record(s), and/or credit request record(s) which may include other records for the particular customer's purchase. Also in step 110, the presumed identity of the current customer may be checked against database 95 of known previously validated customers, such as customers who have already proceeded through steps 10 through 70 previously described.

If the customer has been previously validated, their order may be processed through any one of a number of known methods such as electronic download of software, or shipping if the products are physical in nature. Alternatively, the tentative order may be stored to any one of a number of known storage means such as a database 115. However, if the customer has been not been previously validated, their order is held and in at least one embodiment of the present invention, a decision 120 is made as to how to validate the customer. In at least one embodiment, customer validation is completed prior to applying a charge to a credit card or otherwise initiating the charging process. In so doing, the user of the present method may avoid chargeback or other processing fees in the event that it is unable to verify the customer.

At step 120, a practitioner of the method of the present invention may chose from one of a number of methods of validating the customer. The choice of validation method may be based on any one of a number of factors such as available resources, either financial or equipment available to the user of the method, value of the goods subject to the relevant purchase, or according to other factors relevant to the particular user of the method. In an exemplary embodiment, a determination as to which of a number of available validation methods is to be used may be based, at least in part, on an analysis of the present transaction coupled with an analysis of the fraud history associated with transactions similar to the present transaction. For example, a user of the present method may maintain a database 175 which tracks information relating to items purchased, value of items purchased, time of day in which orders are placed, payment methods, and even geographic information regarding the locations from which purchases are made. By data mining this database, the user of the present method may be able to identify certain purchasing characteristics which may indicate a greater likelihood of attempted fraud. For example, if a user of the present method identifies that a certain increased percentage of all purchases of a particular product are fraudulent, the user may elect to use more stringent validation processes to validate any future customers who attempt to purchase that particular product. Conversely, a user may opt to consistently employ less stringent validation methods for certain low-risk purchases, such as, for example, purchases in which the value of the goods purchased are below a particular threshold. By identifying similarities between the present transaction and any similar transactions in the database, the practitioner may determine a fraud risk associated with the present transaction and select a validation method that is appropriate for the present transaction.

Regardless of the validation method employed, at step 120 the potential customer is notified that their account will be validated, and will be provided instructions if necessary.

In one embodiment, the potential customer may be validated through an automated telephonic system 130. For example, automated telephonic validation means 130 may require that the potential customer place an inbound telephone call to a particular telephone number associated with the automated validation means. In some embodiments, the potential customer may also be provided with an alphanumeric identification code, which may or may not be unique to that particular customer, to be entered by the potential customer upon connection with the automated system and thereby received by the system. Additionally, at step 140 the automated system may or may not compare the Caller ID of the call and or the alphanumeric code entered by the potential customer to confirm that one or both match the telephone number that the potential customer registered with the user of the present method in step 10 and or the alphanumeric code previously provided. If the telephone number does not match the registered telephone number, the merchant may be notified of the call and the potential customer may be informed to call back from the correct, registered telephone number (not shown). If the potential customer is able to place a call from the correct telephone number, in some embodiments (not depicted in FIG. 2), the user of the present method may determine that, within an acceptable degree of certainty the order is valid and thus the present method continues to step 160 where the order will be finalized and the ordered products delivered to the customer.

While some practitioners of the present method will elect to move to step 160 following confirmation of the incoming Caller ID information, as it is known that it is possible to falsify Caller ID information, sometimes known as “spoofing,” in an exemplary embodiment, the present method offers an additional layer of security which may combat this tactic. Specifically, even if the potential customer is able to place a call from what appears to be the correct telephone number, a practitioner may elect to verify that the potential customer is actually calling from the number shown in the Caller ID. In one embodiment, the present method includes step 150 in which the potential customer is then informed that it will receive a telephone call within 30 seconds.

In step 150, an outbound call is initiated to the registered telephone number associated with that potential customer. In some embodiments, the potential customer may be instructed during this call that their account associated with the payment method entered in step 80 (credit/debit/PayPal, etc) has been debited for a purchase in a specific amount. If at step 150 the potential customer is able to verify the transaction, by for example, providing a voice command or, if at step 130 an alphanumeric identification code was provided, by entering that code, the present method moves to step 160 where the order will be finalized and the ordered products delivered to the customer.

If, at step 150 the potential customer is not able to verify the transaction, such as, for example, a situation where the person answering the telephone has been the victim of identity theft and is unaware that a third party is attempting to use their credit card for an unauthorized transaction, in one embodiment, the present method may move to step 170 where a manual account verification process may be initiated.

Returning to step 120, if for any reason the method of the present invention determines that the telephone validation system described in steps 130, 140 and 150 is not appropriate, in one embodiment, the method may move to step 180 where an alternate verification method may be employed.

In one embodiment, at step 180, the present method may employ any one of a number of known verification methods such as a third party system of the type offered by a company such as IDology, Inc. In such a system, the practitioner of the present method has access, either directly or through a third party, to a database of data relating to some segment of the population. This data can include any number of data records gathered from either public or private sources or both. For example, such a database may include government records such as those related to driver's licenses, state issued identification cards, military identifications, immigration records, vehicle registrations and professional licenses. Of course, these records frequently include personal information such as date of birth, a record of past residences, and vehicle ownership information. By utilizing this data, the practitioner of the present method, either directly or through a third party provider, may craft any number of queries that may be presented to a potential customer. Queries may be structured in any form, although multiple choice forms may be most efficient from a processing standpoint. For example, potential customers may be asked to answer 3 simple, non-financial related questions about themselves to validate their account. Sample questions could include queries regarding past addresses, date of birth, military history, or questions relating to vehicle ownership (make and model of vehicle for example). In general, the queries will be designed such that the answers will be generally known only by the potential customer or at least will be of a type such that the correct answers are not readily ascertainable by one other than the potential customer. If the potential customer is able to answer 3 of 3 questions correctly (or as many or at whatever rate of success as defined by the practitioner), the present method moves to step 160 where the order will be finalized and the ordered products delivered to the customer. If the potential customer is unable to satisfy the practitioner's requirement, the present method may move to step 170 where a manual account verification process may be initiated.

At step 170, the manual account verification process of the present invention involves a person reviewing potential customer data for any discrepancies in the data provided. For example, the manual reviewer may analyze IP addresses used by the potential customer to place the order. If the geographic location of the IP address is not acceptably close to the physical address of the potential customer, the manual reviewer may elect to cancel the potential order. Similarly, the manual review process may analyze the value of the order, and other characteristics in an attempt to determine the likelihood that the order is non-fraudulent. If following the manual verification process, the practitioner is satisfied that the potential customer is legitimate, the present method moves to step 160 where the order will be finalized and the ordered products delivered to the customer. If the manual verification process is unable to validate the potential customer, the order is rejected. In one embodiment, any data gathered during any portion of the present method may be entered into security database 175 such that it will be available for future data mining if desired.

In an alternate embodiment of the present method, a practitioner of the method may add additional security screens and checkpoints to the system. For example, based on transaction history and the practitioner's knowledge, it may elect to automatically engage manual account verification depending on, for example, the goods purchased, the value of the goods to be purchased, or the ZIP code or area code/exchange of the telephone number associated with the transaction. In this embodiment, these additional security measures may be engaged regardless of whether the potential customer has been able to pass through the automatic security measures previously described.

Although the invention has been disclosed and described in relation to its preferred embodiments with a certain degree of particularity, it is understood that the present disclosure of some preferred forms is only by way of example and that numerous changes in the details of operation and in the combination and arrangements of steps may be resorted to without departing from the spirit of the scope of the invention as claimed here.

1. A method for verifying the identify of online consumers comprising the steps of:
registering a customer, including receiving a customer ZIP code and a customer telephone number having a customer area code and customer exchange; and
verifying customer identity wherein said step of registering a customer involves the steps of receiving a customer ZIP code, receiving a customer telephone number, and calculating the distance between said customer ZIP code and at least one of said customer area code and said customer exchange.

2. The method of claim 1, further comprising the steps of:
setting a distance threshold; and
completing said step of registering a customer if said distance is less than said distance threshold.

3. The method of claim 2 wherein said step of registering a customer further comprises the steps of:
receiving customer address information;
receiving customer payment information;
transmitting said payment information to a verification means wherein said verification means includes a database of known customer information; and
determining if said customer address information agrees with said known customer information.

4. The method of claim 3, wherein said step of determining if said customer address information agrees with said known customer information determines that said customer address information does agree with said known customer information, further comprising the steps of:
allowing said customer to select items for purchase, said items comprising a potential transaction; and
determining if said customer is a validated customer.

5. The method of claim 4, wherein if said step of determining if said customer is a validated customer determines that said customer is not a validated customer, then further comprising the steps of:
analyzing said potential transaction;
comparing said potential transaction to a database of known transactions;
identifying similarities between said potential and said known transactions to determine a fraud risk associated with said potential transaction; and
selecting a validation method based on said fraud risk.

6. The method of claim 5 wherein said validation method comprises the step of:
validating said customer using automated telephonic validation means.

7. The method of claim 6 wherein said automated telephonic validation means comprise the steps of:
requesting that said customer place an inbound telephone call to a predetermined telephone number; and
comparing the caller identification information associated with said inbound telephone call with said customer telephone number.

8. The method of claim 7 further comprising the steps of:
providing said customer with an alphanumeric identification code;
receiving input from said customer during said inbound telephone call; and
comparing said input with said alphanumeric identification code.

9. The method of claim 8, wherein if said step of comparing said input with said alphanumeric identification code determines that said input and said alphanumeric identification code agree, then further comprising the step of finalizing said potential transaction and delivering said items to said customer.

10. The method of claim 8 further comprising the steps of:
placing an outbound telephone call to said customer telephone number; and
verifying that said customer is able to receive said outbound telephone call to said customer telephone number.

11. The method of claim 10, wherein if said step of verifying that said customer is able to receive said outbound telephone call to said customer telephone number determines that said customer is able to receive said outbound telephone call to said customer telephone number, then further comprising the step of finalizing said potential transaction and delivering said items to said customer.

12. The method of claim 5 wherein said validation method comprises the steps of:
presenting at least one query to said customer regarding said customer, wherein said query tests said customer's knowledge of data that would be generally known only to said customer.

13. The method of claim 12 further comprising the steps of:
defining a success rate, wherein if said customer is able to correctly answer a number of said at least one query at a rate that is greater than said success rate, then finalizing said potential transaction and delivering said items to said customer.

14. The method of claim 10, wherein if said step of verifying that said customer is able to receive said outbound telephone call to said customer telephone number determines that said customer is not able to receive said outbound telephone call to said customer telephone number, then further comprising the step of manually reviewing at least one of said customer address information, said customer payment information and said potential transaction.

15. The method of claim 1 wherein the step of calculating the distance between said customer ZIP code and at least one of said customer area code and said customer exchange is performed according to the following calculation:
r*acos[sin(lat1)*sin(lat2)+cos(lat1)*cos(lat2)*cos(lon2−lon1)],
where: r is the radius of the Earth in miles (3963.0 (statute miles)); lat1 is the latitude of a first location; lon1 is the longitude of a first location; lat2 is the latitude of a second location; and lon2 is the longitude of a second location and wherein said first location is the location of said customer ZIP code and said second location is the location of said customer telephone number.

16. The method of claim 1 further comprising the step of setting a target threshold, wherein if said step of calculating the distance between said customer ZIP code and at least one of said customer area code and said customer exchange returns a distance which is greater than said target threshold, then the additional step of alerting said customer that the customer has not been registered.

17. The method of claim 16 wherein said target threshold is 100 miles.

18. The method of claim 16 wherein said target threshold is 55 miles.
